(19) United States
(12) Patent Application Publication
(10) Pub. No.: US 2025/0188332 A1
(43) Pub. Date: Jun. 12, 2025

(54) LIGNIN-BASED ADHESIVES

(71) Applicant: UNIVERSITY OF SOUTH CAROLINA, COLUMBIA, SC (US)

(72) Inventors: CHUANBING TANG, COLUMBIA, SC (US); YISHAYAH BENSION, COLUMBIA, SC (US)

(21) Appl. No.: 18/908,184

(22) Filed: Oct. 7, 2024

Related U.S. Application Data
(60) Provisional application No. 63/607,149, filed on Dec. 7, 2023.

(51) Int. Cl. C09J 197/00; C08K 5/5419

(52) U.S. Cl. CPC C09J 197/005; C08K 5/5419

(57) ABSTRACT

In general, the present disclosure is directed to an adhesive composition. The adhesive composition may include a functionalized lignin and a hardener. For instance, the hardener may include a silyl ether. The functionalized lignin and hardener may be present in the adhesive composition at a weight ratio of from about 1:10 to about 10:1.

### CROSS REFERENCE TO RELATED APPLICATION

The present application claims priority to U.S. Provisional Patent Application Ser. No. 63/607,149, having a filing date of Dec. 7, 2023, all of which is incorporated herein by reference in its entirety.

### GOVERNMENT SUPPORT CLAUSE

This invention was made with government support under grant number 1806792 awarded by the National Science Foundation (NSF). The government has certain rights in the invention.

### BACKGROUND

Modern day commercial adhesives are derived from petrochemical feedstocks, which are not sustainable. One way to improve the sustainability of commercial polymers is to utilize bio feedstocks such as lignin. Lignin is one of the most abundant natural polymers derived from plants. Lignin is often burned as a waste product.

To create sustainable adhesives many factors must be considered such as surface energies of substates, adhesion mechanism, and the application conditions. Latex adhesives that work well for ductile substrates do not work on brittle surfaces such as metals or wood. Therefore, it is rare to find an adhesive that can bond to a diverse number of substrates adequately. As such, a need exists in the art for compositions and methods for forming an improved adhesive.

Beneficially, the lignin based adhesive compositions and methods disclosed herein may be useful in the application of a sustainable adhesive for use in harsher environments. Conventional adhesives are manufactured from acrylates and epoxides which pose safety and environmental risks due to their toxic emissions.

### SUMMARY

Aspects and advantages of the invention will be set forth in part in the following description, may be apparent from the description, or may be learned through practice of the invention.

In general, the present disclosure is directed to an adhesive composition. The adhesive composition may include a functionalized lignin and a hardener. For instance, the hardener may include a silyl ether. The functionalized lignin and hardener may be present in the adhesive composition at a weight ratio of from about 1:10 to about 10:1.

Also, the present disclosure is directed to an adhesive article. The adhesive article, for instance, may include the adhesive composition disclosed herein. Also, the adhesive article, for instance, may include a substrate.

Also, the present disclosure is directed to method of forming an adhesive article. The method may include providing an adhesive composition disclosed herein and a substrate. Also, the method may include contacting the adhesive composition disclosed herein with a surface of the substrate. Additionally, the method may include curing the adhesive composition disclosed herein and the substrate to form an adhesive resin at the surface of the substrate.

These and other features and aspects, embodiments and advantages of the present invention will become better understood with reference to the following description and appended claims.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 depicts (a) synthesis of thiol silyl ethers; (b) synthesis of allyl lignin; (c) click chemistry between allyl lignin and thiol silyl ethers sandwiched between two substrates.

FIG. 2A depicts an FT-IR spectra analysis of allyl lignin and cured lignin by DSE-50.

FIG. 2B depicts a DSC trace of curing of allyl lignin by DSE-50.

FIG. 3 depicts exemplary images of TSE-50 on glass plates: before curing; after curing; and after lap shear break.

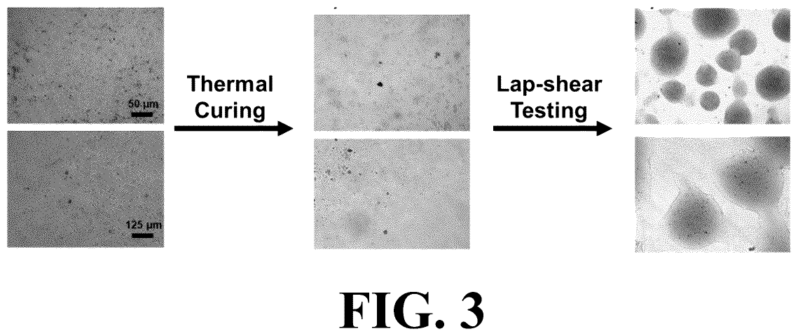

FIG. 4A depicts adhesion performance with different substrates by DSE adhesives.

FIG. 4B depicts adhesion performance with different substrates by TSE adhesives.

FIG. 4C depicts an exemplary image of a lignin adhesive on steel prior to lap-shear testing.

FIG. 4D depicts an exemplary image of a lignin adhesive on steel after lap-shear testing.

FIG. 5 depicts reaction scheme and mechanistic experiments of adhesion on steel plates with non-silicone containing a functionalized lignin with tetrathiol crosslinker (PTMP); peroxide crosslinker (DCP); neatTSE-50, and TSE-50 immersed in tetra-n-butylammonium fluoride (TBAF).

FIG. 6 depicts rheological plots of TSE-50 before curing.

FIG. 7 depicts a schematic representation of a prolonged load test of an exemplary adhesive.

FIG. 8 depicts adhesion performance of TSE-50 under dry and wet conditions (e.g., exposed to air and immersed in water or sea water) for 21 days.

FIG. 9 depicts 1H NMR spectra of allylated lignin (top) and organosolv lignin (bottom).

FIG. 10 depicts FT-IR spectra of allylated lignin (top) and organosolv lignin (bottom).

FIG. 11 depicts 31P NMR spectra of different hydroxyl and carboxylic acid groups of allylated lignin (top) and organosolv lignin (bottom).

### DETAILED DESCRIPTION

Reference will now be made in detail to various embodiments of the presently disclosed subject matter, one or more examples of which are set forth below. Each embodiment is provided by way of explanation, not limitation, of the subject matter. In fact, it will be apparent to those skilled in the art that various modifications and variations may be made to the present disclosure without departing from the scope or spirit of the disclosure. For instance, features illustrated or described as part of one embodiment, may be used in another embodiment to yield a still further embodiment. Thus, it is intended that the present disclosure cover such modifications and variations as come within the scope of the appended claims and their equivalents.

In general, the present disclosure is directed to compositions and methods for forming a lignin based adhesive. The lignin based adhesive composition may include a lignin and a hardener. The hardener, for instance, may be a crosslinker. To form the lignin based adhesive composition, the lignin and hardener may be mixed together. Beneficially, the lignin based adhesive composition disclosed herein is chemically stable in aqueous and organic media, mechanically strong and capable of binding with a diverse number of substrates.

The lignin based adhesive compositions disclosed herein provide a sustainable hardener combined with a biopolymer that can be directly applied as a strong adhesive between a diverse array of substrates. The designed hardeners may have strong adhesion, thermal resistance, and water resistance.

In some example embodiments, the lignin based adhesive may include lignin or a derivative thereof. “Lignin” as used herein refers to complex organic polymer found in the cell walls of many plants that is composed of three types of monolignols: p-coumaryl alcohol, coniferyl alcohol, and sinapyl alcohol. Lignin can be obtained from a variety of plant-based sources, particularly from the byproducts of industries that process lignocellulosic biomass. Lignin, for instance, may be obtained from wood, including both softwoods and hardwoods, where lignin constitutes a significant portion of the plant cell wall. Lignin may also be derived from agricultural residues such as wheat straw, corn stover, sugarcane bagasse, and rice husks. Lignin is produced in large quantities as a by-product of the paper and pulp industry, as well as in various other industries such as biofuels, chemicals, and materials. For instance, pulp and paper mills produce lignin as a byproduct during the kraft and sulfite pulping processes. Additionally, lignin can be sourced from energy crops like switchgrass and miscanthus, as well as other fibrous plants such as flax and hemp.

In some example embodiments, the lignin may be present in the lignin based adhesive composition in an amount of at least 25 wt. % lignin, such as at least about 50 wt. % lignin, or such as at least 75 wt. % lignin, based on the lignin based adhesive composition weight.

In some example embodiments, the lignin (or functionalized lignin as defined herein) may have an average molecular weight (Mw) of about 30,000 g/mol or less, such as about 20,000 g/mol or less, such as about 10,000 g/mol or less, such as about 5,000 g/mol or less, such as about 3,000 g/mol or less. In some example embodiments, the lignin may have an average Mw of about 1,000 g/mol or more, such as about 3,000 g/mol or more, such as about than 5,000 g/mol or more, such as about 10,000 g/mol or more, such as about 20,000 or more. In one example embodiment, the lignin may have an average Mw in the range of about 1,000 g/mol to about 30,000 g/mol, or any range therebetween.

Any suitable lignin may be included in the lignin based adhesive composition. The lignin, for instance, may include, but is not limited to, Kraft lignin (obtained from the Kraft process), sulfonated lignin, Lignoboost® lignin, precipitated lignin, filtered lignin, acetosolv lignin, or organosolv lignin. In one example embodiment, the lignin may be selected from Kraft lignin, acetosolv lignin, or organosolv lignin. In another example embodiment, the lignin may be Kraft lignin.

In some example embodiments, the lignin may be organosolv lignin. “Organosolv lignin” as used herein refers to a type of lignin extracted through the organosolv process, which involves breaking down lignocellulosic biomass using organic solvents such as ethanol, methanol, acetone, or acetic acid in the presence of water. This process selectively separates lignin from cellulose and hemicellulose, producing lignin with a lower molecular weight, higher purity, and less structural modification compared to lignin obtained from other processes like kraft or sulfite pulping.

In some example embodiments, the lignin may be a functionalized lignin. For instance, the functionalized lignin may be present in the lignin based adhesive composition in an amount of at least 25 wt. % functionalized lignin, such as at least about 50 wt. % functionalized lignin, or such as at least 75 wt. % functionalized lignin, based on the lignin based adhesive composition weight.

For instance, functionalization of lignin may improve its adhesive properties. The lignin may be functionalized by installing reactive groups such as alkenes, alkynes, or epoxides. In some example embodiments, for instance, functionalization may include, but is not limited to, amination, oxidation, allylation, acetylation, sulfomethylation, etc. may introduce functional groups or structural changes that broaden lignin's utility in fields such as bioplastics, adhesives, coatings, and pharmaceuticals. These modifications often involve reactions targeting lignin's phenolic hydroxyl, aliphatic hydroxyl, and/or methoxyl groups. For instance, the abundance of hydroxyl moieties on lignin allows for further functionalization such as amination, oxidation, and allylation.

In one example embodiment, the functionalized lignin may be an allylated lignin. As used herein, “allylated lignin” refers to a functionalized lignin, where allyl groups are introduced into the lignin structure. This process typically involves reacting lignin with allyl halides, such as allyl bromide or allyl chloride, in the presence of a base. Allylation increases lignin's reactivity by introducing unsaturated carbon-carbon double bonds, which can serve as reactive sites in further chemical processes like crosslinking or polymerization. Allylated lignin may exhibit improved compatibility with other polymeric materials, making it suitable for producing thermosetting resins and elastomers. Additionally, the introduction of allyl groups may enhance lignin's thermal stability and UV resistance.

In one example embodiment, the functionalized lignin may be an acetylated lignin. As used here, “acetylated lignin” refers to a functionalized lignin, where lignin is treated with acetic anhydride, leading to the formation of acetyl esters. Acetylation reduces the number of free hydroxyl groups in lignin, thus decreasing its hydrophilicity. This functionalized may be useful in enhancing lignin's compatibility with hydrophobic polymers and materials, facilitating its use as a reinforcing agent in biocomposites and polymer blends.

In one example embodiment, the functionalized lignin may be a sulfonated lignin. As used herein, “sulfonated lignin” refers to a functionalized lignin that has undergone sulfomethylation, where lignin is treated with formaldehyde and sodium sulfite. This process introduces sulfonate groups into the lignin structure, significantly enhancing its water solubility and dispersion capabilities. Sulfonated lignins have found extensive application in industrial processes, particularly as dispersants, emulsifiers, and additives in cement, dyes, and drilling fluids. The presence of sulfonate groups makes these lignins ideal for applications where water compatibility and dispersibility are essential.

In one example embodiment, the functionalized lignin may be an aminated lignin. As used herein, “aminated lignin” refers to amination of lignin, which introduces amino groups (—NH₂) into its structure, enhancing its interaction with other materials. Amination is typically achieved through reactions such as reductive amination or Mannich reactions, where lignin's phenolic or aliphatic hydroxyl groups react with amines. This process creates lignin derivatives with improved water solubility and increased adhesion properties, making amine-modified lignin suitable for use in adhesives, surface coatings, and as a component in resins. Aminated lignin may also be employed in wastewater treatment, where the amino groups enhance the lignin's ability to chelate heavy metals and capture contaminants.

In one example embodiment, the functionalized lignin may be an oxidized lignin. As used herein, “oxidized lignin” refers to oxidation of lignin, which involves the introduction of oxygen-containing functional groups, such as aldehydes, ketones, or carboxyl groups, which alter lignin's reactivity and hydrophilicity. Oxidized lignin may be useful applications like dispersants, where the carboxyl groups improve solubility and interaction with water. Additionally, oxidized lignin can be further processed into value-added chemicals such as vanillin or bio-based phenols, offering sustainable alternatives to petrochemical-derived compounds.

The lignin may undergo various chemical modifications or derivations to improve its reactivity and functionality for various applications. For instance, modifications of the lignin may include, but is not limited to, fractionation, polymerization, and the like.

In one example embodiment, the modified lignin may be a polymerized lignin. As used herein, “polymerized lignin” refers to polymerization of lignin, which involves the linking of modified lignin units into higher-molecular-weight structures, often through free-radical or condensation polymerization techniques. This process creates lignin-based polymers with enhanced mechanical properties and thermal stability, suitable for biocomposites, plasticizers, and thermosetting resins. Lignin can be copolymerized with synthetic monomers, such as styrene, to create materials with improved strength, flexibility, or conductivity. Lignin-based polymers may be a useful renewable alternative to petroleum-based plastics, contributing to the development of sustainable materials for packaging and construction.

In addition to chemical modifications, the lignin may also by modified via physical derivations. For example, fractionation techniques, such as ultrafiltration or solvent extraction, can be used to separate lignin into distinct molecular weight fractions. These fractions may exhibit varying properties, such as differing degrees of reactivity and solubility, making them more suitable for specific applications. In one example embodiment, the modified lignin may be an unfractionated lignin. In another example embodiment, the modified lignin may be a fractionated lignin.

In some example embodiments, the lignin based adhesive composition may include a hardener. The hardener, for instance, may be a crosslinker. The hardener may crosslink the lignin based adhesive composition via suitable and compatible crosslinking methods. For instance, the hardener may crosslink the lignin based adhesive composition via thiol-ene chemistry, in which thiol groups react with carbon-carbon double bonds (e.g., alkenes) to form thioether linkages. This reaction proceeds via a free radical mechanism and can be triggered by UV light, heat, or chemical initiators. This results in a covalently crosslinked lignin based adhesive composition that may improve the mechanical and thermal properties of the lignin based adhesive composition.

In some example embodiments, the hardener may be an organosilicon compound. The organosilicon compound may include a thiol compound and a silane compound. In one example embodiment, the organosilicon compound may include 11-mercapto-1-undecanol and dichlorodiisopropylsilane. In another example embodiment, the organosilicon compound may include 11-mercapto-1-undecanol and tetrachlorosilane. For instance, the organosilicon compound may include a thiol silyl ether as a crosslinker. For instance, the hardener including a thiol silyl ether crosslinker may include a disilyl crosslinker, a tetrasilyl crosslinker, or a combination thereof. In one example embodiment, the thiol silyl ether crosslinker may be a disilyl crosslinker. In another example embodiment, the thiol silyl ether crosslinker may be a tetrasilyl crosslinker.

In one example embodiment, the hardener may be a dithiol silyl ether (DSE) crosslinker. “DSE” as used herein refers to a class of compounds that contain two thiol (—SH) groups along with a silyl ether structure. For instance, the DSE crosslinker may include, but is not limited to, dimethyldimethoxysilane, diisopropyldimethoxysilane, diisobutyldimethoxysilane, t-butylmethyldimethoxysilane, dicyclopentyldimethoxysilane, diphenyldimethoxysilane, phenylmethyldimethoxysilane, bis-o-tolydimethoxysilane, bis-m-tolydimethoxysilane, bis-p-tolydimethoxysilane, biscthylphenyldimethoxysilane, dicyclohexyldimethoxysilane, cyclohexylmethyldimethoxysilane, 2-norboranemethyldimethoxysilane, or a combination thereof. In one example embodiment, the DSE may be 11,11′-((diisopropylsilanediyl)bis(oxy))bis(undecane-1-thiol).

In another example embodiment, the hardener may be a tetrathiol silyl ether (TSE) crosslinker. “TSE” as used herein refers to a class of compounds that contain four thiol (—SH) groups along with a silyl ether moiety. For instance, the TSE crosslinker may include, but is not limited to, tetramethyl orthosilicate, tetraethyl orthosilicate, methyl triethyl orthosilicate, dimethyl diethyl orthosilicate, tetrapropyl orthosilicate, tetraisopropyl orthosilicate, tetrabutyl orthosilicate, tetra secondary butyl orthosilicate, tetra tertiary butyl orthosilicate, tetrahexyl orthosilicate, tetracyclohexyl orthosilicate, tetradodecyl orthosilicate, or a combination thereof. In one example embodiment, the TSE crosslinker may be tetrakis(11-mercaptoundecyl) silicate.

The adhesion properties may be adjusted by tuning the weight ratio of functionalized lignin and hardener. For instance, the functionalized lignin and hardener may be present in the lignin based adhesive composition at a weight ratio of from about 1:10 to about 10:1, such as from about 1:5 to about 5:1, such as from about 1:4 to about 4:1, such as from about 1:3 to about 3:1, such as from about 1:2 to about 2:1, or any range therebetween. In one example embodiment, the functionalized lignin and hardener may be present in the lignin based adhesive composition at a weight ratio of about 1:4. In another example embodiment, the functionalized lignin and hardener may be present in the lignin based adhesive composition at a weight ratio of about 4:1. In another example embodiment, the functionalized lignin and hardener may be present in the lignin based adhesive composition at a weight ratio of about 1:1. In yet another example embodiment, the functionalized lignin and hardener may be present in the lignin based adhesive composition at a weight ratio of about 1:2. In another example embodiment, the functionalized lignin and hardener may be present in the lignin based adhesive composition at a weight ratio of about 2:1.

In some example embodiments, the lignin based adhesive composition may include a solvent. Any suitable solvent may be utilized to solubilize the functionalized lignin and hardener. In some example embodiments, the solvent may include, but is not limited to, ethyl acetate, water, methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, cyclohexanol, or a combination thereof. In one example embodiment, the solvent may be ethyl acetate. In another example embodiment, the solvent may be water.

In some example embodiments, the lignin based adhesive composition may be integrated into an article to form an adhesive article. For instance, the adhesive article may include the lignin based adhesive composition disclosed herein and a substrate. For instance, the substrate may be an organic or inorganic substrate. In some example embodiments, for instance, the substrate may be an organic substrate. In some example embodiments, for instance, the substrate may be an inorganic substrate. For instance, the substrate may include, but is not limited to, wood, glass, steel, aluminum, carbon fiber, plastic, or a combination thereof. In one example embodiment, the substrate may be wood. In another example embodiment, the substrate may be glass. In yet another example embodiment, the substrate may be steel. In another example embodiment, the substrate may be aluminum. In another example embodiment, the substrate may be carbon fiber. In yet another example embodiment, the substrate may be plastic.

For instance, plastic may include, but is not limited to, a polyolefin, a polyimide, a polyester, a polyamide, poly(phenylene ether), a polycarbonate, a styrene-acrylonitrile copolymer, polyethylene terephthalate, polybutylene terephthalate, polystyrene, polystyrene derivatives, polyphenylene oxide, polyoxymethylene, fluorine-containing thermoplastic resins, or a mixture thereof.

In one example embodiment, the plastic may include, but is not limited to, at least a polyolefin. The polyolefin can be formed by polymerizing one or more alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another alpha-olefin such as 1-butene, 1-hexene, 1-octene, 2-methyl-1-propenc, 3-methyl-1-pentene, 4-methyl-1-pentene, 5-methyl-1-hexene or mixtures thereof may be also utilized. In one example embodiment, when the primary monomer is ethylene, the copolymer may be propylene or another C₄-C₈ alpha-olefin monomer. In one example embodiment, the comonomer may be propylene. In another example embodiment, the comonomer may be a C₄-C₈ alpha-olefin monomer, such as hexene. When the primary monomer is propylene, the copolymer may be ethylene or another C₄-C₈ alpha-olefin monomer. In one example embodiment, the comonomer may be ethylene. In another embodiment, the comonomer may be a C₄-C₈ alpha-olefin monomer.

Other suitable polyolefin copolymers may include copolymers of olefins with styrene such as styrene-ethylene copolymer or polymers of olefins with α,β-unsaturated acids, α,β-unsaturated esters such as polyethylene-acrylate copolymers. Non-olefin thermoplastic resins may include polymers and copolymers of styrene, α,β-unsaturated acids, α,β-unsaturated esters, and mixtures thereof. For example, polystyrene, polyacrylate, and polymethacrylate may be used.

In one example embodiment, the polyolefin may be an ethylene polymer, a propylene polymer, or a mixture thereof. For instance, the polyolefin may be an ethylene polymer. In another example embodiment, the polyolefin may be a propylene polymer. In a further example embodiment, the polyolefin may be a mixture of an ethylene polymer and a propylene polymer.

The ethylene polymer may be a polyethylene homopolymer in one embodiment. In another embodiment, the ethylene polymer may be an ethylene copolymer. For instance, the ethylene polymer may have a particular density. In one example embodiment, the ethylene polymer may be a, a low density polyethylene (LDPE), a medium density polyethylene (MDPE), a high density polyethylene (HDPE), or a combination thereof. Such polyethylenes may have a particular density as determined in accordance with ASTM D792. For instance, a low-density polyethylene (LDPE) may have a density in the range of from about 0.91 g/cm³ to about 0.925 g/cm³. A medium density polyethylene (MDPE) may have a density in the range of from about 0.926 g/cm³ to about 0.94 g/cm³. Also, a high-density polyethylene (HDPE) may have density in the range of from about 0.941 g/cm³ to about 0.965 g/cm³. In one example embodiment, the ethylene polymer may be a low-density polyethylene. In a further example embodiment, the ethylene polymer may be a medium density polyethylene. In another example embodiment, the ethylene polymer may be a high-density polyethylene.

In one example embodiment, the plastic may include, but is not limited to, high-density polyethylene (HDPE), poly(vinyl chloride) (PVC), poly(methyl methacrylate) (PMMA), poly(tetrafluoroethylene) (PTFE), or a combination thereof. For instance, the plastic may be HDPE. In another example embodiment, the plastic may be PVC. In another example embodiment, the plastic may be PMMA. In another example embodiment, the plastic may be PTFE.

In some example embodiments, to form the adhesive article, the lignin based adhesive composition including solubilized functionalized lignin and hardener may be applied to a surface of the substrate using methods well known in the art. For instance, the lignin based adhesive composition may be applied to the surface of the substrate by spraying, ribbon application, liquid extrusion, curtain coating, as a foam, or by brushing. However, it should be understood that other methods of application may be utilized and such application method is not limited by the present disclosure. In one example embodiment, the lignin based adhesive composition may be applied to the surface of the substrate using a doctor blade. In one example embodiment, the lignin based adhesive composition may be applied to the surface of a first substrate. In another example embodiment, the lignin based adhesive composition may be applied to the surface of a first substrate, and subsequently, the lignin based adhesive composition may be applied to the surface of a second substrate. In some example embodiments, the first and second substates may be the same substrates. In some example embodiments, the first and second substates may be different substrates. Nevertheless, the first and second substates may be pressed together to enhance adhesive contact between the two substrates.

In some example embodiments, the lignin based adhesive composition may be cured onto the substrate to form an adhesive resin. The curing process may be initiated through methods well known in the art based on the specific substrate and desired adhesive properties. For example, thermal curing may be employed, where the lignin based adhesive composition may be heated to induce crosslinking reactions between the thiol and functional groups within the functionalized lignin, forming a strong, durable adhesive resin. Alternatively, UV or visible light curing may be employed in combination with photoinitiators, particularly for applications where rapid curing is desired, or where heat-sensitive substrates are involved. In addition to thermal and UV curing, chemical curing using catalysts such as amines, peroxides, or Lewis acids may also be employed to promote crosslinking at room or ambient temperatures.

In some example embodiments, the lignin based adhesive composition may be cured onto the substrate at a temperature of from about 90° C. to about 150° C., such as from about 100° C. to about 140° C., such as from about 110° C. to about 130° C., or any range therebetween. In one example embodiment, the lignin based adhesive composition may be cured at a temperature of about 110° C.

Surprisingly, the lignin based adhesive composition may maintain adhesion to the substrate for more than about 7 days, such as more than about 14 days, such as more than about 21 days, such as more than about 28 days. In one example embodiment, for instance, the lignin based adhesive composition may maintain adhesion to the substrate for more than about 14 days. In another example embodiment, for instance, the lignin based adhesive composition may maintain adhesion to the substrate for more than about 21 days.

In some example embodiments, the cured adhesive resin to be applied to an article may have a lap shear strength of at least about 1 MPa, such as at least about 2 MPa, such as at least about 3 MPa, such as at least about 4 MPa, based on ASTM D1002 (2019). For instance, in one example embodiment, the cured adhesive resin may have a lap shear strength of at least about 1 MPa. In another example embodiment, the cured adhesive resin may have a lap shear strength of at least about 2 MPa. In yet another example embodiment, the cured adhesive resin may have a lap shear strength of at least about 3 MPa.

It is understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

### EXAMPLES

### Example 1

### Lignin Allylation

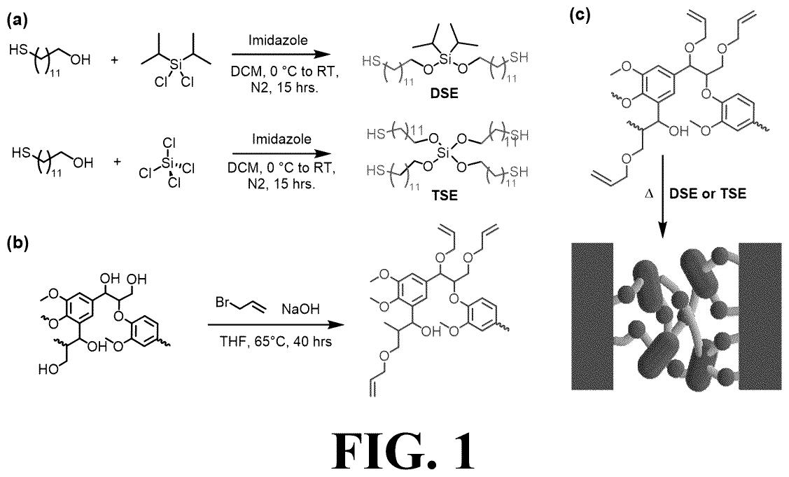

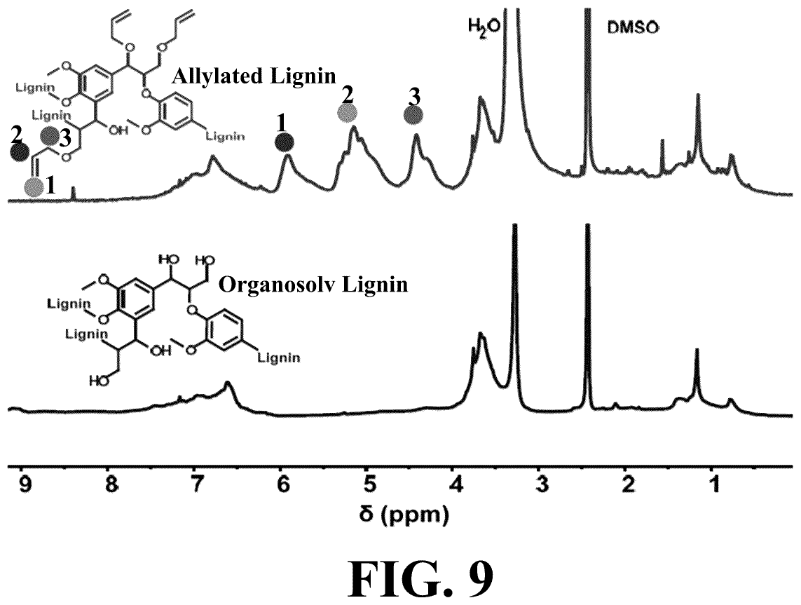

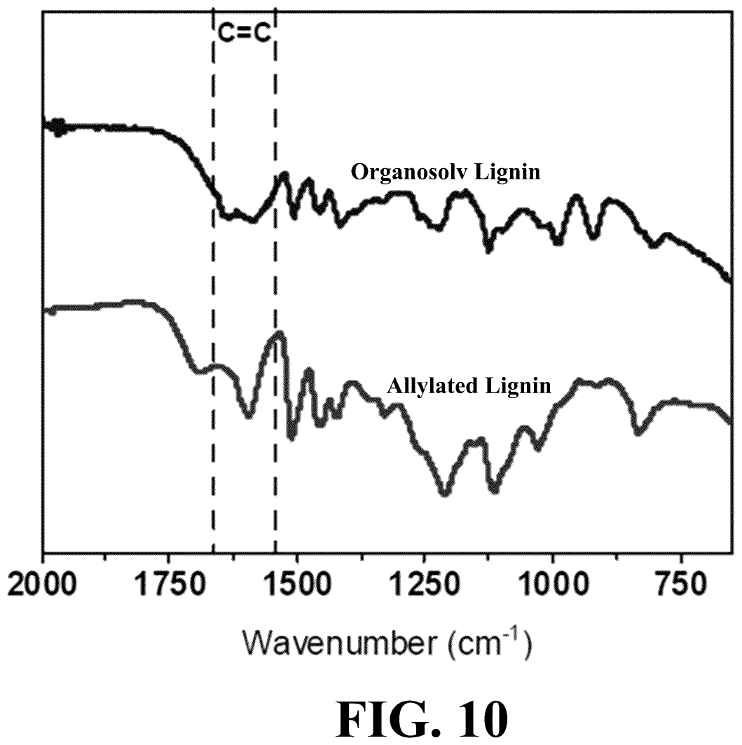

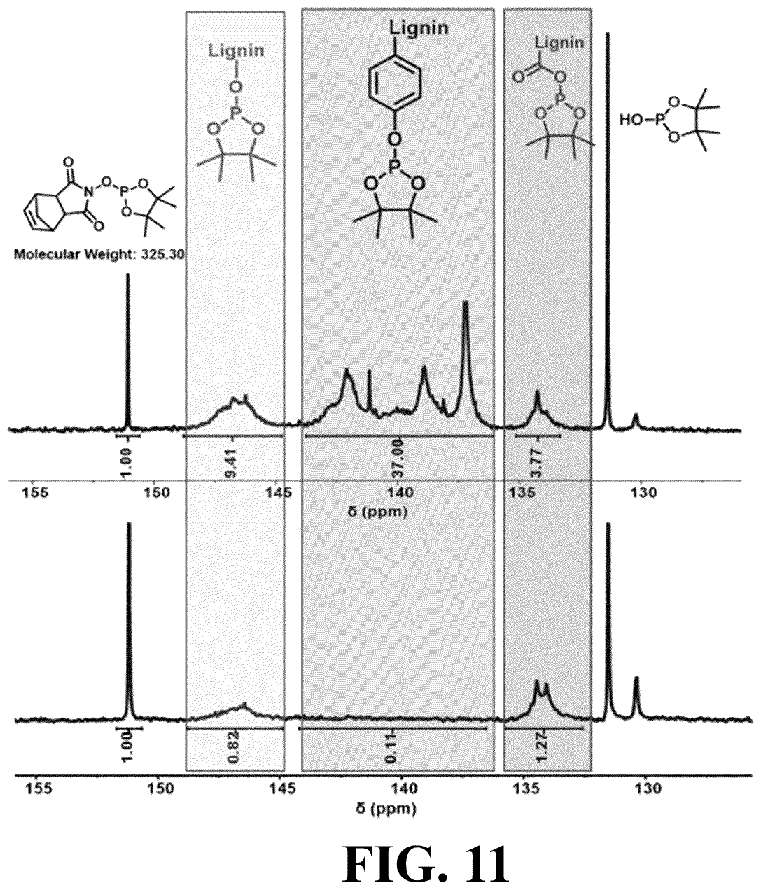

Unfractionated lignin (5.5 g) was dissolved in tetrahydrofuran (THF) (60 mL) and stirred until the solution was homogenous with a light brown color (FIG. 1). Sodium hydroxide (5.5 g, 137.5 mmol) was then dissolved in deionized water (4 mL) and added to the lignin solution. To allylate the lignin, the resulting mixture was stirred while allyl bromide (6.5 g, 53.7 mmol) was slowly added, the temperature was set to 65° C., and the reaction was allowed to stir for 48 hours. Afterwards, the reaction was quenched by adding 0.1 M HCl, and the resulting precipitate was placed under a rotary evaporator to remove the solvent. The brown solid was washed with water and then dried under vacuum with a final dry weight of 7.13 g. The allylation was verified according to ¹H NMR (FIG. 9) and Fourier transform infrared (FT-IR) (FIG. 10). For instance, FT-IR spectra of samples were recorded on an FT-IR spectrometer using an attenuated total reflection (ATR) method. Absorption spectra were recorded at 4 cm 1 resolution, and the signal averaged over 32 scans. The total conversion of hydroxyl groups to allyl groups was calculated to be about 95% according to ³¹P NMR (FIG. 11).

### Example 2

### Synthesis of Hardeners

11-Mercapto-1-undecanol was synthesized as follows: 10-undecen-1-ol (8 g, 47 mmol) was added to a dry flask with a stir bar. Thioacetic acid (3.6 g, 47 mmol) was added, and the mixture was purged with N₂ for 10 min. Benzoin (200 mg, 0.9 mmol) was then dissolved in methanol (0.25 mL) and added to the flask. The reaction was then exposed to UV light (355 nm) overnight, and the resulting mixture was washed with cold dichloromethane (DCM) and then recrystallized with cold methanol to afford crude S-(11-hydroxyundecyl) ethanethioate. The thioester was then refluxed with sodium hydroxide (4 equivalence) in methanol for 12 hours. The reaction was then neutralized with 2M hydrochloric acid (HCl) in ice and mixed with 200 mL of diethyl ether. The organic layer was separated, washed with 100 mL of brine, dried over magnesium sulfate, and filtered. The filtrate was concentrated and then freeze dried to afford 9.4 g of white powder to give 11-mercapto-1-undecanol.

Two different adhesive hardeners were synthesized using 11-mercapto-1-undecanol and two silanes. In a round bottom flask equipped with a stir bar, 11-mercapto-1-undecanol was added to dry DCM and stirred at 0° C. in an ice bath. Imidazole (1 equiv.) was added, and the reaction was purged with nitrogen for 10 minutes. Then a silane (0.25 eq. for tetrachlorosilane and 0.5 eq for dichlorodiisopropylsilane) was added dropwise and a white precipitate formed immediately. The reaction was allowed to warm to room temperature and reacted overnight. The solvent was then evaporated, and the remaining white precipitate was washed with ether and filtered. The ether solution was then dried leaving a yellow liquid. Purification by column chromatography on silica gel (15:1 hexane/ethyl acetate) provided a clear foul-smelling liquid.

To synthesize dithiol silyl ether (DSE), for example, 11-mercapto-1-undecanol (10.0 g) and imidazole (3.3 g) were mixed in 50.0 ml dichloromethane. The solution was purged with N₂ and put into an ice bath at 0° C. After 30 min, dichlorodiisopropylsilane (2.0 g) was added, and the reaction was allowed to warm to room temperature overnight. The solution was filtered, and the filtrate was concentrated and then purified by column chromatography using 20:1 hexanes to ethyl acetate.

To synthesize tetrathiol silyl ether (TSE), for example, 11-mercapto-1-undecanol (10.0 g) and imidazole (3.3 g) were mixed in 50.0 ml dichloromethane. The solution was purged with N₂ and put into an ice bath at 0° C. After 30 min, silicon tetrachloride (4.5 g) was added, and the reaction was allowed to warm to room temperature overnight. The solution was filtered, and the filtrate was concentrated and then purified by column chromatography using 20:1 hexanes to ethyl acetate.

### Example 3

### Formation and Curing of Lignin-Based Adhesives

Adhesives were formulated by mixing lignin and hardener together with appropriate weight ratios. Using TSE-X or DSE-X (see definitions in Table 1) as an example, 250 mg of lignin and 750 mg of hardener were mixed in ethyl acetate, sonicated, and vortexed to make a dispersion. The mixture was allowed to evaporate in the fume hood overnight leading to a viscous mixture. An even layer of adhesive was applied to a surface using a doctor blade, and then another surface was placed on top of the layer to sandwich the adhesive. The system was then cured at a temperature of 100° C.-120° C. overnight and then allowed to warm to room temperature.

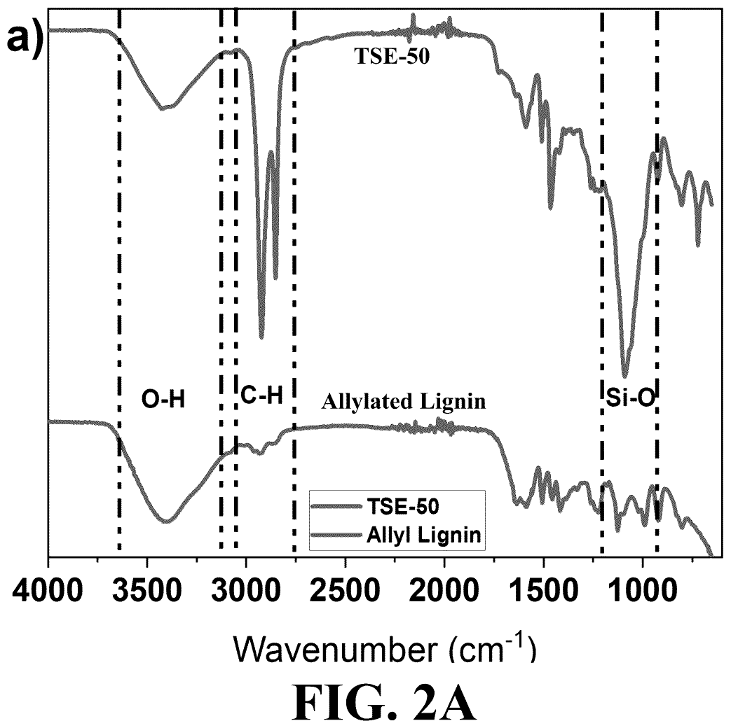

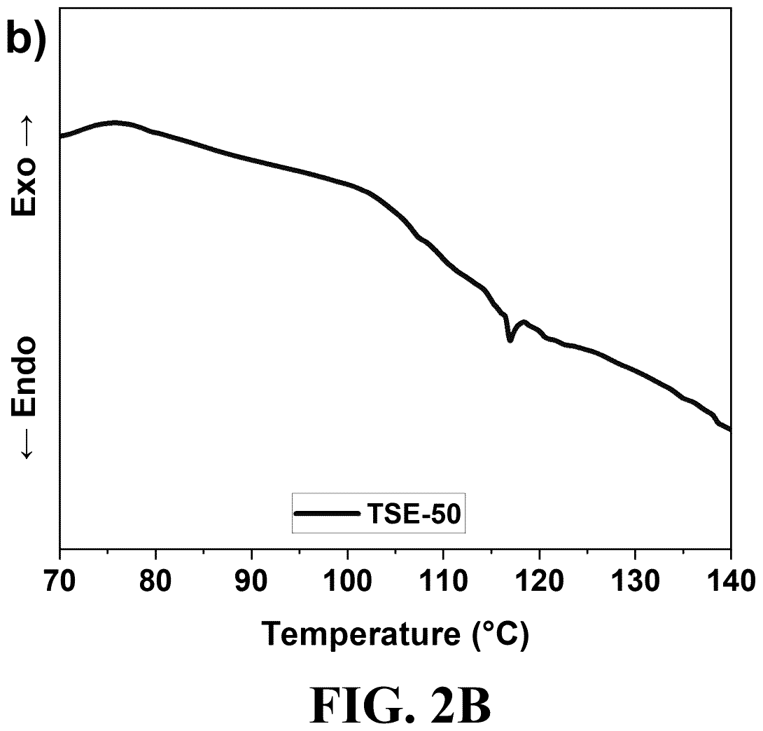

To form the TSE lignin-based adhesives, for instance, functionalized lignin was mixed with TSE-50 (50 wt. %) in a minimum amount of ethyl acetate. The mixture was allowed to rest, evaporating all the solvent, and leaving a pasty brown residue. The residue was applied using a syringe to an aluminum surface and then sandwiched between another aluminum plate. The resulting plates were cured for 2 hours at 100° C. in a vacuum oven to ensure the complete conversion of thiols and alkenes to thioethers, and then removed and placed inside a hood. FTIR spectra show the strong peaks of Si—O and C—H bonds at 1086 cm-1 and 2920 cm-1 respectively, compared to the allylated lignin (FIG. 2A). The curing process began around 117° C. based on differential scanning calorimeter (DSC) tracing of curing of allyl lignin by DSE-50 (FIG. 2B). To perform DSC, for instance, the sample (5-10 mg) was encapsulated in a 40 μL aluminum pan. The sample was submitted to heating from 25° C. to 200° C. with a heating rate of 10° C./min under a nitrogen atmosphere.

To form the DSE lignin-based adhesives, for instance, functionalized lignin was mixed with DSE-75 (75 wt. %) in a minimum amount of acetone. The mixture was allowed to rest, evaporating all the solvent, and leaving a pasty brown residue. The residue was applied using a doctor blade to a wood surface and then sandwiched between another wood plate. The resulting plates were cured for 6 hours at 120° C. in a vacuum oven and then removed and placed inside a hood.

TABLE 1
Adhesive compositions of lignin and thiol silyl ethers
(DSE-X* or TSE-X*)

| Adhesive | Lignin, | DSE, | TSE, |
|---|---|---|---|
| Code | wt % | wt % | wt % |
| DSE-25 | 25 | 75 | 0 |
| DSE-50 | 50 | 50 | 0 |
| DSE-75 | 75 | 25 | 0 |
| TSE-25 | 25 | 0 | 75 |
| TSE-50 | 50 | 0 | 50 |
| TSE-75 | 75 | 0 | 25 |

X* is wt. % of allyl lignin.

### Example 4

### Adhesion Strength of Lignin Based Adhesives

Lap shear testing was carried out to measure the adhesion strength of the lignin based adhesives disclosed herein. To do so, substrates such as stainless steel 304, 5052 aluminum, glass, wood, carbon fiber, high-density polyethylene (HDPE), poly(vinyl chloride) (PVC), poly(methyl methacrylate) (PMMA), and poly(tetrafluoroethylene) (PTFE) were washed and sonicated with ethanol and then dried under vacuum for 48 hours. The substrates were then placed in a Diener zepto one plasma cleaner and cleaned under oxygen for 5 minutes.

Adhesives were applied and cured as discussed in Example 3. Lap shear tests were performed according to ASTM D1002 (2019). The substrate dimensions were 101.6 mm×25.4 mm×2 mm with a shear area of 12.7 mm×25.4 mm yielding the total surface area for adhesives at 322.6 mm². Single lap joint was performed in triplicate on a Zwick Z010 with a grip surface area at 645.2 mm² on each side.

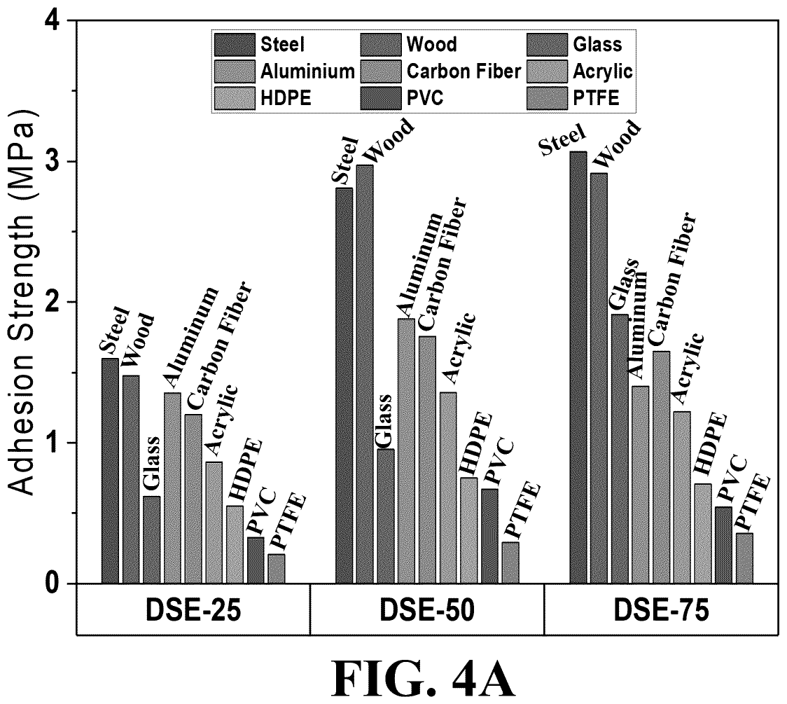

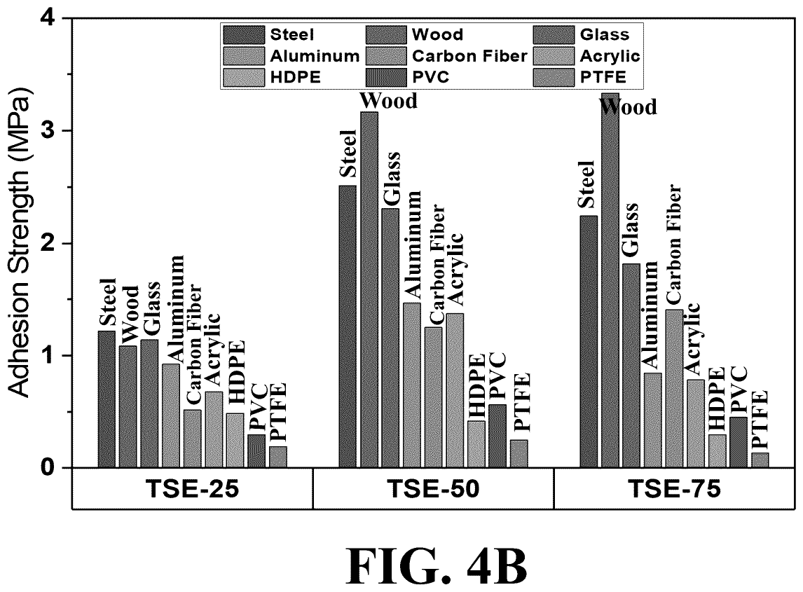

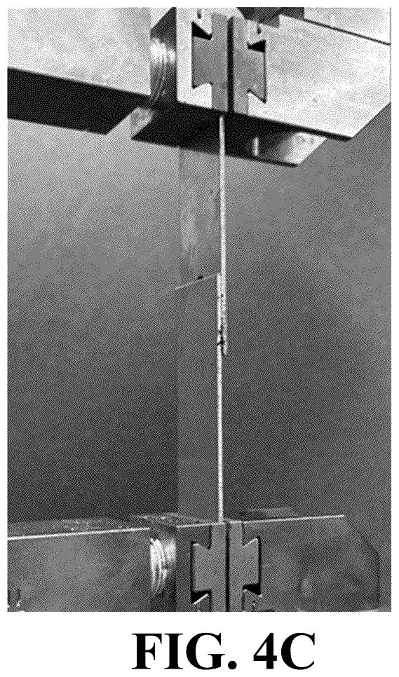

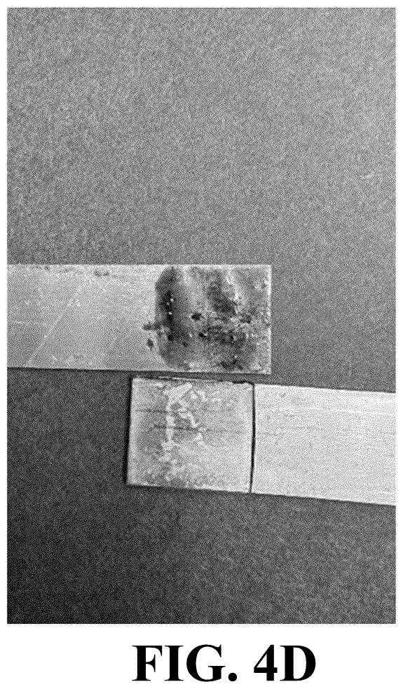

Several factors may affect adhesion performance including substrate surface energy, adhesive viscosity, and crosslinker chemistry. The adhesion strength for each of the substrates was determined. (FIG. 4A). Among the various substrates tested, steel and wood generally performed the best. It is known that plasma cleaning can increase the polarity of a steel surface and thus surface energy. The increase in polarity, combined with the smoothness of the surface, makes steel an ideal substrate for most adhesives. This can be seen with adhesion strength of over 2.0 MPa for many of the adhesives with lignin contents at 50 wt. % and 75 wt. %. Unexpectedly, the adhesives on wood substrates performed well. Since wood is uneven and porous, adhesive wetting of wood is often poor, leaving voids in the adhesive layer. Despite this challenge, it was observed the wood adhesion herein is comparable to or even better than that of steel. Without wishing to be bound by theory, it is believed that this could be due to the lignin presence in wood, which acts as a natural glue between cellulose and hemicellulose and may also offer good adhesion in lap-shear testing.

Also unexpectedly, glass adhesion was higher than expected since it typically possesses low surface energy. The chemistry of the crosslinkers was examined to help rationalize the unexpected observation. Traditional glass adhesives contain either cyanoacrylates or silicone groups, which interact with the moisture on the glass surface. Whereas, the hardeners herein include siloxane units. Without wishing to be bound by theory, it is believed the siloxane units may promote improved compatibility and thus better adhesion between adhesives and glass surface.

Aluminum and carbon fiber displayed similar adhesion strength for each adhesive. Aluminum's oxide layer can often impair the adhesive layer. This minimizes the interactions between the adhesive and the substrate thus weakening the bond. Despite these hurdles, adhesion strength around 1.5 MPa was obtained for aluminum and carbon fiber when the lignin contents were 50 wt. % and 75 wt. %.

Additionally, the adhesion performance of organic polymer substrates was examined. With higher contents of lignin, the adhesives on acrylic or PMMA plastics exhibited the highest adhesion strength (1-1.5 MPa) due to the polarity of substrates, which allows for stronger noncovalent interactions with free thiol and hydroxyl groups on lignin. HDPE and PVC displayed similar adhesion strengths despite the latter being polar. Without wishing to be bound by theory, it is believed one possible explanation is the lack of hydrogen bonding in PVC. Lastly, PTFE possesses the lowest surface energy due to its inert C—F bonds that restrict interactions between the adhesive and the polymer. PTFE gave the lowest adhesion strength, less than 0.5 MPa.

For adhesives with 25 wt. % of lignin (DSE-25 and TSE-25), lower adhesion strength was observed for all substrates (FIGS. 4A-4B). This was attributed to the presence of excess thiols, which could induce a plasticizing effect that would lead to weaker adhesion. Once the free thiol content is reduced, the plasticizing effect is greatly reduced, making the adhesives stronger with higher lignin contents.

### Example 5

### Mechanism of Adhesion

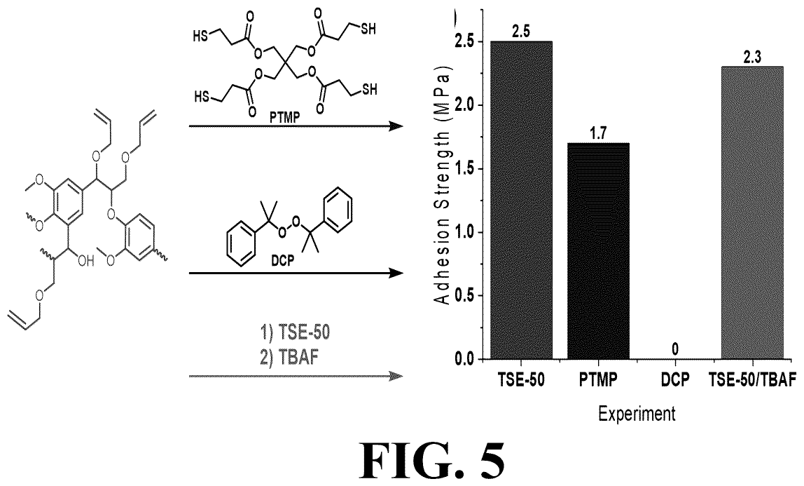

FIG. 5 shows the experiments to determine what effect each reaction component has on the adhesives. First, raw lignin was crosslinked with dicumyl peroxide (DCP) to create an adhesive resin between two plates. However, upon curing no adhesion was observed. Raw lignin is brittle and mechanically weak, so it was not surprising that just crosslinked lignin was insufficient for adhesion; instead, a crosslinker had to be used.

Next, the effect of silyl ethers was evaluated through two experiments. Pentaerythritol tetrakis(3-mercaptopropionate) (PTMP) was chosen due to its tetra functionality and similarity to TSE. As shown in FIG. 5, with lignin at 50 wt %, adhesion strength on steel plates was observed to be 1.7 MPa, significantly lower than 2.5 MPa for TSE-50. This result suggested that the silyl ether enhances the adhesion most likely due to nonbonding interactions with the surface. To further investigate this claim, TSE-50 was immersed in 1 M tetra-n-butylammonium fluoride (TBAF) in THF overnight to cleave Si—O bonds. A minor reduction in adhesion strength was observed (FIG. 5), without wishing to be bound by theory, it is believed this may indicate that either the adhesive seal was too strong to degrade or the resulting alcohols from the silyl ether cleavage may also participate in the adhesion process.

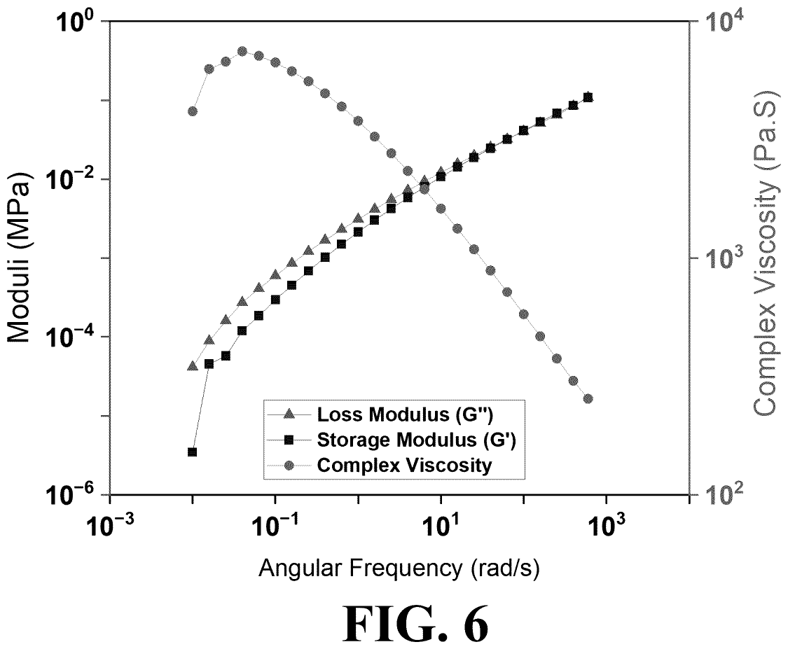

Many adhesives fail to bond wooden substrates due to their porous surfaces. One important factor is the ability of adhesives to maintain contact with the wood surfaces without being absorbed into the substrate. Given the high adhesion on wood substrates, the rheology of TSE-50 adhesive resin at room temperature was studied (FIG. 6). Rheological analyses were measured using a suitable rheometer using a stainless-steel Peltier plate with a diameter of 40 mm. Rheological measurements were performed at 25° C. using a solvent trap to avoid evaporation during measurements. Oscillation frequency sweep measurements were performed at the shear strain of 1% with an angular frequency of 10 rad s 1, duration of 300 s and a soak time of 180 s.

The TSE-50 resin displays highly viscous behavior even at higher frequencies. The high viscosity is advantageous when the adhesive is applied to wood surfaces, which are typically not smooth. During the curing process adhesives may be absorbed into the wooden pores thus lowering the wettability and the adhesion. In the case of this viscous adhesive, an even layer of TSE-50 is present and is not absorbed into the wooden substrate which maximizes the adhesion surface area.

The adhesion mechanism was also explored by molecular dynamics simulations by modeling the interface between lignin and cellulose (representing the wood substrate). Cellulose was chosen because it is a major component of wood and the adhesion strength for the lignin-wood interface is among the strongest (FIG. 4A). Additionally, the cellulose surface has multiple polar groups that could potentially participate in nonbonding interactions with the lignin. The (100) surface of I-β cellulose crystal was simulated as it has a higher density of alcohol groups compared with other crystalline planes. The simulations were non-reactive, and therefore the curing mechanism, which requires a detailed modeling of bond formation and scission, was not explored. Instead, the simulations studied the nonbonding interactions including the van der Waals and electrostatic interactions to evaluate their roles in adhesion. Although the lack of covalent bonding interactions in the simulations, the interfacial energy between raw lignin and cellulose was calculated to be (100±9) mJ/m², which agrees with previously published studies of lignin-cellulose interfaces. This interfacial energy is weak compared to adhesion strength based on covalent bonding interactions. Using a conservative estimate of the covalent bond energy as 100 KJ/mol, the interfacial energy of 100 mJ/m² is converted to 1 covalent bond per area of 13 Å². In contrast, a cured system may have at least 6 covalent bonds in the same interfacial area, assuming each bond of length 1.5 Å occupies an area of 2.25 Å². As a result, the adhesive's non-bonding interactions alone are not enough to explain the high adhesive strength observed experimentally in the cured system.

### Example 6

### Adhesion Applications

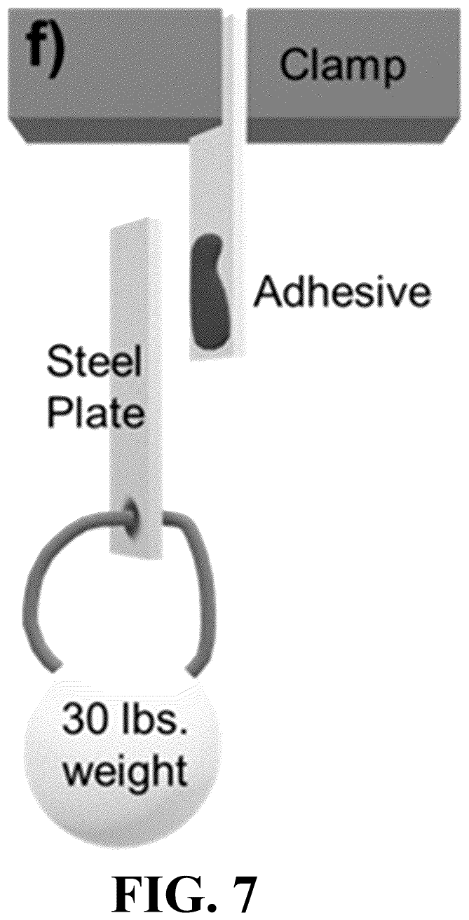

The TSE-50 adhesive composition was selected for testing its application by applying it to flexible and rigid plastics. When exposed to flow, the adhesive composition acted as a plug to block the leakage of liquid. This further indicated its efficacy as an adhesive and demonstrated the adhesive's water resistance. FIG. 7 demonstrates TSE-50 ability to withstand loads at a prolonged time. Even after 21 days the adhesive resin was able to maintain its adhesion.

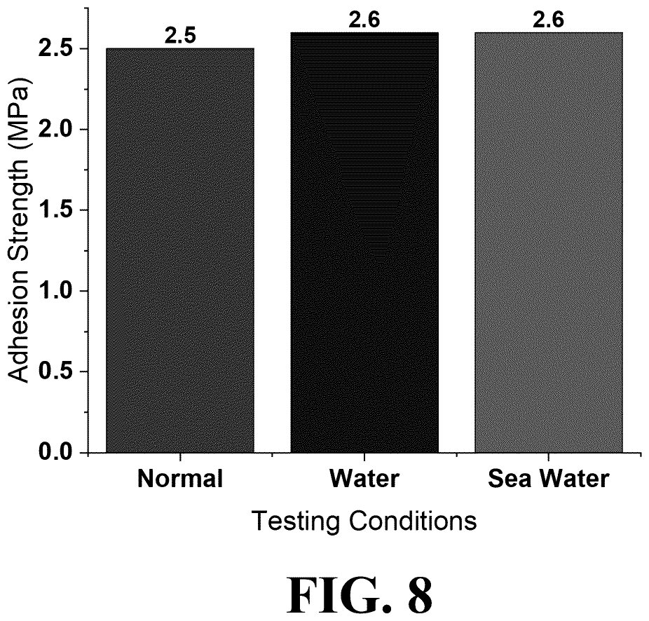

Also, the TSE-50 adhesive composition was tested in aqueous conditions to determine what effect, if any, wet environments had on the adhesion strength (FIG. 8). Two TSE-50 samples were prepared by sandwiching the adhesive composition between steel substrates. One sample was submerged in distilled water and the other sample was submerged in 3 wt. % NaCl in water mimicking the composition of seawater. Both samples were submerged for 21 days and then the adhesion force was recorded. The adhesion strength did not change regardless of testing conditions. Beneficially, the adhesion strength may be attributed to the adhesive being crosslinked with non-hydrolysable bonds. This result further supported the observations from FIG. 7, indicating the durability of this adhesive underwater.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. An adhesive composition, comprising:
a functionalized lignin; and
a hardener comprising a silyl ether,
wherein the functionalized lignin and the hardener are present in the adhesive composition at a weight ratio of from about 1:10 to about 10:1.

2. The adhesive composition of claim 1, wherein the functionalization of the functionalized lignin is selected from a group consisting of amination, oxidation, allylation, acetylation, sulfomethylation, or a combination thereof.

3. The adhesive composition of claim 1, wherein the functionalized lignin comprises an allylated lignin.

4. The adhesive composition of claim 1, wherein at least 25 wt. % of functionalized lignin is present in the adhesive composition.

5. The adhesive composition of claim 1, wherein at least 50 wt. % of functionalized lignin is present in the adhesive composition.

6. The adhesive composition of claim 1, wherein the silyl ether comprises a dithiol silyl ether (DSE) or a tetrathiol silyl ether (TSE).

7. The adhesive composition of claim 6, wherein the DSE comprises dimethyldimethoxysilane, diisopropyldimethoxysilane, diisobutyldimethoxysilane, t-butylmethyldimethoxysilane, dicyclopentyldimethoxysilane, diphenyldimethoxysilane, phenylmethyldimethoxysilane, bis-o-tolydimethoxysilane, bis-m-tolydimethoxysilane, bis-p-tolydimethoxysilane, bisethylphenyldimethoxysilane, dicyclohexyldimethoxysilane, cyclohexylmethyldimethoxysilane, 2-norboranemethyldimethoxysilane, or a combination thereof.

8. The adhesive composition of claim 6, wherein the TSE comprises tetramethyl orthosilicate, tetraethyl orthosilicate, methyl triethyl orthosilicate, dimethyl diethyl orthosilicate, tetrapropyl orthosilicate, tetraisopropyl orthosilicate, tetrabutyl orthosilicate, tetra secondary butyl orthosilicate, tetra tertiary butyl orthosilicate, tetrahexyl orthosilicate, tetracyclohexyl orthosilicate, tetradodecyl orthosilicate, or a combination thereof.

9. An adhesive article, the article comprises the adhesive composition of claim 1 and a substrate.

10. The adhesive article of claim 9, wherein the substrate comprises an organic or inorganic substrate.

11. The adhesive composition of claim 9, wherein the substrate comprises wood, glass, steel, aluminum, carbon fiber, various plastics, or a combination thereof.

12. A method of forming an adhesive article, the method comprising:
providing an adhesive composition comprising a functionalized lignin and a hardener comprising a silyl ether;
providing a substrate;
contacting the adhesive composition with a surface of the substrate; and
curing the adhesive composition and the substrate to form an adhesive resin at the surface of the substrate,
wherein the functionalized lignin and the hardener are present in the adhesive composition at a weight ratio of from about 1:10 to about 10:1.

13. The method of claim 12, wherein the substrate comprises wood, glass, steel, aluminum, carbon fiber, plastic, or a combination thereof.

14. The method of claim 12, wherein the adhesive composition is cured to the surface of the substrate via thermal curing.

15. The method of claim 12, wherein the adhesive composition is cured at a temperature of from about 90° C. to about 150° C.

16. The method of claim 12, wherein the functionalization of the functionalized lignin is selected from a group consisting of amination, oxidation, allylation, acetylation, sulfomethylation, or a combination thereof.

17. The method of claim 16, wherein the functionalized lignin comprises an allylated lignin.

18. The method of claim 12, wherein the silyl ether comprises a dithiol silyl ether (DSE) or a tetrathiol silyl ether (TSE).

19. The method of claim 18, wherein the DSE comprises dimethyldimethoxysilane, diisopropyldimethoxysilane, diisobutyldimethoxysilane, t-butylmethyldimethoxysilane, dicyclopentyldimethoxysilane, diphenyldimethoxysilane, phenylmethyldimethoxysilane, bis-o-tolydimethoxysilane, bis-m-tolydimethoxysilane, bis-p-tolydimethoxysilane, bisethylphenyldimethoxysilane, dicyclohexyldimethoxysilane, cyclohexylmethyldimethoxysilane, 2-norboranemethyldimethoxysilane, or a combination thereof.

20. The method of claim 18, wherein the TSE comprises tetramethyl orthosilicate, tetraethyl orthosilicate, methyl triethyl orthosilicate, dimethyl diethyl orthosilicate, tetrapropyl orthosilicate, tetraisopropyl orthosilicate, tetrabutyl orthosilicate, tetra secondary butyl orthosilicate, tetra tertiary butyl orthosilicate, tetrahexyl orthosilicate, tetracyclohexyl orthosilicate, tetradodecyl orthosilicate, or a combination thereof.
